(19) United States
(12) Patent Application Publication
(10) Pub. No.: US 2013/0329880 A1
(43) Pub. Date: Dec. 12, 2013

(54) METHOD AND SYSTEM FOR IMPROVING THE PRODUCTIVITY OF CALLING AGENTS AND CALL YIELD

(71) Applicant: Interactive Intelligence, Inc., Indianapolis, IN (US)

(72) Inventors: Warren Bentley, Baltimore, MD (US); Roger Leblanc, St-Jean-sur-Richelieu (CA); Mark R. Stumpf, Carmel, IN (US)

(21) Appl. No.: 13/910,446

(22) Filed: Jun. 5, 2013

Related U.S. Application Data
(60) Provisional application No. 61/657,925, filed on Jun. 11, 2012.

(51) Int. Cl. H04M 3/523

(52) U.S. Cl. CPC H04M 3/5238
USPC 379/265.1

(57) ABSTRACT

A method and system for increasing call yield and the productivity of agents in an environment such as a contact or call center, for example, is described. Attributes may be used to classify calls and contact information. A system may learn from collected data. Calculations may be performed to aid in forecasting such as probabilities, call yield, and expected call handle time. Such calculations may be used to determine the best time to call a contact to achieve a desired result.

### BACKGROUND

The present invention generally relates to telecommunication systems and methods and performing machine learning. More particularly, the present invention pertains to the techniques that increase productivity of calling agents and call yield within these systems.

### SUMMARY

A method and system for increasing call yield and the productivity of agents in an environment such as a contact or call center, for example, is described. Attributes may be used to classify calls and contact information. A system may learn from collected data. Calculations may be performed to aid in forecasting such as probabilities, call yield, and expected call handle time. Such calculations may be used to determine the best time to call a contact to achieve a desired result.

In one embodiment, a method is provided for increasing productivity in a contact center, the method comprising the steps of: requesting contact information from a database; parsing dimension values of said contact information provided by said database and extracting specified dimension values; producing records containing said specified dimension values; performing a series of calculations to determine an expected call handle time value, a call yield value, and a probability for each result code for a said dimension value; and determining a forecast of probability, an expected handle time, and an expected call yield for a set of result codes.

In another embodiment, a method is provided for increasing total yield in a contact center, the method comprising the steps of: requesting contact information from a database; parsing dimension values of said contact information provided by said database and extracting specified dimension values; producing records containing said specified dimension values; performing a series of calculations to determine a call yield value and a probability for each result code for a said dimension value; and determining a forecast of probability and an expected call yield for a set of result codes.

In another embodiment, a method is presented for increasing productivity in a contact center, the method comprising the steps of: requesting contact information from a database, wherein said database is capable of determining an effective outcome for call yield; parsing dimension values of said contact information provided by said database and extracting specified dimension values; producing records containing said specified dimension values; performing a series of calculations to determine an expected call handle time value, a call yield value, and a probability from a result code for said dimension value wherein said calculations comprise one or more of the following: searching a historical record for each dimension value for an ability of said value to obtain a desired code in a mathematically appropriate manner; pooling a probability of each resulting value and determining a probability in a mathematically appropriate manner; determining a weighted average of the handle times of a call in a mathematically appropriate manner; pooling values for each desired result code across all desired result codes in a mathematically appropriate manner; and determining a forecast of an expected handle time and an expected call yield.

In another embodiment, a system for increasing productivity in a contact center is presented, the system comprising: means for requesting contact information from a database capable of determining an effective outcome for a call yield; means for parsing dimension values of said contact information; means for producing records containing said specified dimension values; means for performing a series of calculations to determine an expected call handle time value, a call yield value, and a probability for each result code for a said dimension value; and means for determining a forecast of probability, an expected handle time, and an expected call yield for a set of result codes.

In another embodiment, a system for increasing total yield in a contact center is presented, the system comprising: means for requesting contact information from a database; means for parsing dimension values of said contact information provided by said database and extracting specified dimension values; means for producing records containing said specified dimension values; means for performing a series of calculations to determine a call yield value and a probability for each result code for a said dimension value; and means for determining a forecast of probability and an expected call yield for a set of result codes.

### BRIEF DESCRIPTION OF THE DRAWINGS

FIG. 1 is a diagram illustrating the basic components of the system.

FIG. 2 is a flow chart illustrating an embodiment of a process of determining a forecast.

FIG. 3 is a sample table illustrating the dimension definition record.

FIG. 4 is a sample table illustrating the dimension—contact list cross references record.

FIG. 5 is a sample table illustrating the dimension value record.

FIG. 6 is a sample table illustrating the dimension value superkey record.

FIG. 7 is a sample table illustrating the dimension string value record.

FIG. 8 is a sample table illustrating the dimension integer band record.

FIG. 9 is a sample table illustrating the nominal date in time record.

FIG. 10 is a sample table illustrating the dimension day record.

FIG. 11 is a sample table illustrating the special day rule definition record.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Businesses experience problems in determining the best use of their resources, such as agents, Interactive Voice Response (IVR) capacity, agent skillsets, etc., in contacting accounts within their portfolios. Agents may have a large number of accounts and they are often presented with a decision on which one to contact in order to maximize resources. Determining the best time to call each contact to achieve a desired outcome consumes time, energy, and resources. Calls may take more, or less, time to handle than expected in several time slots, while other calls may not be made at all. In order to remain productive, agents may call accounts that were not scheduled in order to fill time gaps. Often, other accounts may unexpectedly call in to resolve an issue, requiring an agent to unexpectedly handle these calls. As a result, the agent's previously set schedule will become unorganized and resources may not be efficiently utilized.

A method and system for increasing call yield and the productivity of agents is described. In at least one embodiment, the method and system may be applied in a contact or call center. By forecasting accurately the best time to reach a contact, contact may be made with the right party as opposed to leaving a message with the wrong party. An example of a wrong party may be a call to a person who is not the targeted contact or to an answering machine. Codes may be employed to track the outcome of a call. Examples of such codes may include: success, right party, wrong party, answering machine, busy, no answer, other handled by an agent, or other handled by a machine. The result codes may be condensed from a wrap code, or a character string designating the classification of what occurred during the call. Additionally, dimension values may be used within the system as a means of classifying and collecting data. A dimension may be an attribute for which forecasts are created. Dimensions may be automatic, demographic, time descriptive, etc.

Automatic dimensions may be extracted from a call as the system handles the call and normally processes it. Automatic dimensions may include, but not be limited to, the following examples: the result of the call, the type of telephone used, the length of the call, the time that a contact is placed on hold before the agent responds, whether the call is escalated, and if so, how far the call is escalated, the time zone offset of the phone, and the time zone name of the phone. A type of telephone may include a cellular telephone, a land line, a home telephone, a work telephone, a primary telephone number, etc. The time zone offset of the telephone may also be calculated based on the minutes east of UTC (“Coordinated Universal Time”).

Time dimensions may be extracted from a call and in consideration of the time the call was initiated or dialed. Time dimensions may include, but not be limited to, the following information: the time of day taken in fifteen minute intervals, the day of the week, the month of the year, the year of the call, etc.

Demographic dimensions may be extracted from particular values in particular fields or columns in the list database tables. Demographic dimensions may be defined by a user or this information may be provided. Demographic dimensions may also be conditionally defined. For example, the Canadian Postal Code may be conditionally defined only if the field is in the form “ANA NAN”, where A and N represent alphabetic and numeric characters. Examples of dimensions that may be defined by the user may include: state/province, primary telephone area code, gender, marital status, balance due, Canadian postal code, UK postal code, US ZIP code, age, credit score, income, profession, residence status, etc. The word “dimension” may be used to designate demographics although they may alternatively be referred to as “attributes”. Differently named columns from different contact lists may be placed in the same dimension, such as “sex” and “gender”. In this example, a range of “1”, “2”, and “3” may be used where M is equivalent to 1, F is equivalent to 2, and U is equivalent to 3 as values for gender. Values of “M”, “F”, and “U” may be used for “sex” where M is male, F is female, and U is unknown. Sex and gender may be interpreted as the same dimension though they may have different mapping rules. Dimension values may be used to place the data from contacts into several groups. Each such group may also have data from many contacts. The data from similar contacts may be grouped to determine the probability of success and to aid in forecasting success, handle time, and yield. The system learns from the data that is collected by updating the number of attempts for each group at a specified time period. Alternatively, the system may update the number of calls completed for each code, each group, each time period, etc.

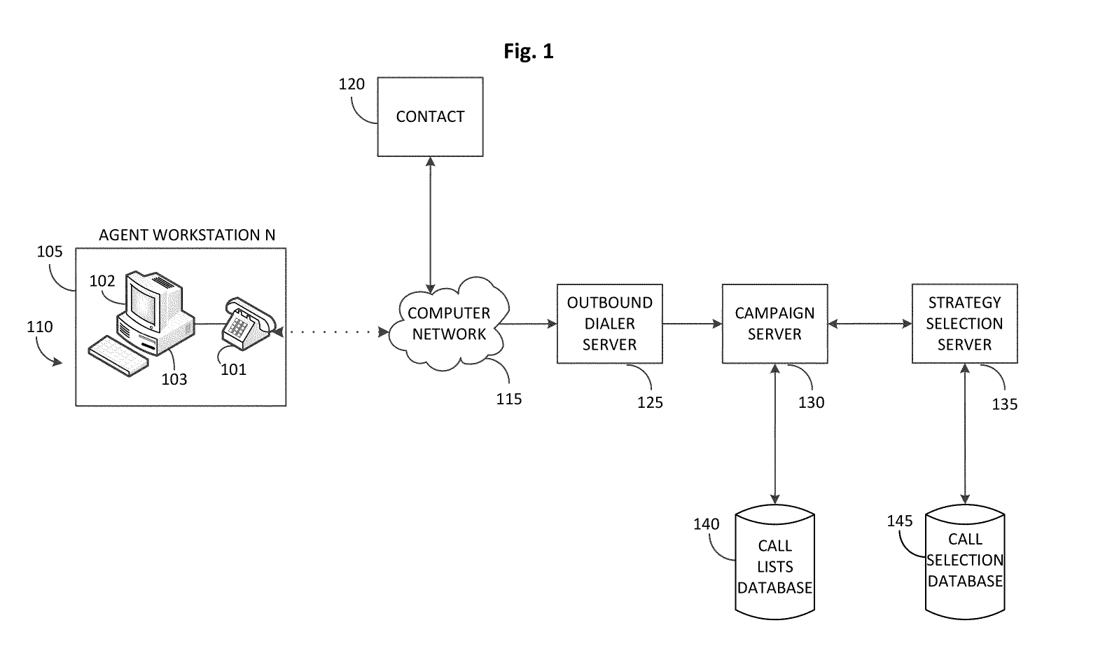

As illustrated in FIG. 1, one embodiment of a system is provided, indicated generally at 100. The system 100 may include a computer network 115 which couples together a number of computers 110 over network pathways. More specifically, system 100 may include several servers, namely the Outbound Dialer Server 125, the Campaign Server 130, and the Strategy Selection Server 135. The system 100 may also include a plurality of agent work stations 105. While only one computer 110 is illustrated, more may be utilized in alternative embodiments.

An agent workstation 105 may include a work station computer 103 coupled to a display 102. Workstation computers 103 may be of the same type, or a heterogeneous combination of different computing devices. Likewise, displays 102 may be of the same type or a heterogeneous combination of different visual devices. It should be understood that while one work station 105 is described in the illustrative embodiment, more may be utilized. Contact center applications of system 100 typically include many more workstations of this type at one or more physical locations, but only one is illustrated in FIG. 1 to preserve clarity.

A digital telephone 101 may be associated with Agent Workstation 105. Additionally, a digital telephone 101 may be integrated into the agent computer 103 and/or implemented in software. It should be understood that a digital telephone 101, which is capable of being directly connected to network 100, may be in the form of handset, headset, or other arrangement as would occur to those skilled in the art. It shall be further understood that the connection from computer network 115 to an agent workstation 105 can be made first to the associated workstation telephone, then from the workstation telephone to the workstation computer by way of a pass through connection on the workstation telephone. Alternatively, two connections from the network can be made, one to the workstation telephone and one to the workstation computer. Although not shown to preserve clarity, an agent workstation 105 may also include one or more operator input devices such as a keyboard, mouse, track ball, light pen, and/or microtelecommunicator, to name just a few representative examples. Additionally, besides display 102, one or more other output devices may be included such as loudspeaker(s) and/or a printer.

The computer network 115 can be in the form of a Local Area Network (LAN), Municipal Area Network (MAN), Wide Area Network (WAN), such as the Internet, a combination of these, or such other network arrangement as would occur to those skilled in the art. The operating logic of system 100 can be embodied in signals transmitted over network 115, in programming instructions, dedicated hardware, or a combination of these. It should be understood that any number of computers 110 can be coupled together by computer network 115.

The Agent Workstation 105 may be connected with the Outbound Dialer Server 125 through the computer network 115 via an agent access application, such as Interactive Intelligence's Interaction Client®. Any number of agents may be utilized. The number of agents may be directly proportional to the effectiveness of the system, thus, more agents may ideally result in a more effective system. The Outbound Dialer Server 125 may communicate between the Agent Workstation 105, the Contact 120, and the Campaign Server 130. A Contact 120 may be an end party that is targeted by an agent, such as one in a call center. The Outbound Dialer Server 125 may manage the activities tied to dialing Contact numbers and maintaining connections throughout a call. Information may be shared between the Outbound Dialer Server 125 and the Campaign Server 130. The Campaign Server 130 may be a server that stores the configuration and through which the Call Lists Database 140, which may contain the contact list, or call list, is accessed.

The Campaign Server 130 may also communicate with the Strategy Selection Server 135. The Strategy Selection Server 135 may perform evaluation of accounts to determine which account to call next. The Strategy Selection Server 135 may be connected with the Call Selection Database 145. The Call Selection database 145 may contain the necessary information for the Strategy Selection Server to determine which contacts to pick in the call lists. Within the Call Selection Database 145, data may be housed that enables the system 100 to determine which account or phone number to call and when the most effective outcome would likely be achieved as is further described below. This information may contain an evaluation of a day of week such as whether or not the day falls on the weekend or a weekday, what week of the year the day is present in, etc. Special days and holidays may also be included in the evaluation.

In one embodiment, the Campaign Server 130 and the Strategy Selection Server 135 may be housed in the same machine though they are presented separately in this instance. In one embodiment, the Call Lists Database 140 and the Call Selection Database 145 may be housed in the same machine though they are presented separately in this instance.

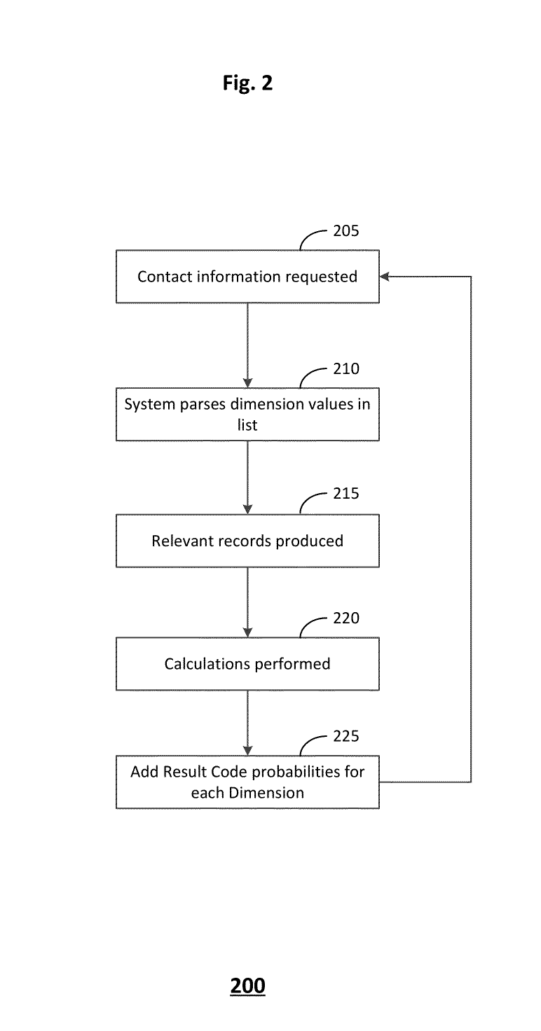

As illustrated in FIG. 2, one embodiment of a process 200 for determining a forecast for call selection is provided. The process 200 may be operative in system 100 (FIG. 1). The process 200 may be repeated multiple times in order to determine a forecast.

In operation 205, contact information may be requested from a database. For example, contact accounts or telephone numbers to call may be requested from the Call Selection Database 145 by an automatic dialer, such as the Outbound Dialer 125 (FIG. 1). The Call Selection Database 145 provides the contact information. Control is passed to operation 210 and process 200 continues.

In operation 210, the system parses dimension values in the list provided by the database. For example, the system performs a series of calculations based on the produced contact records. Accounts to contact may be examined. Relevant dimensions and current values of these dimensions are extracted for these accounts. Each dimension value may apply to more than one contact. For example, a grouping may contain five contacts; each of whom is a woman aged 45 years. Thus, these five contacts have similar dimension values for age (45 years) and gender (female). As previously mentioned, dimension data may be automatic dimension data, time dimension data, and demographic dimension data. Control is passed to operation 220 and process 200 continues.

In operation 215, relevant call records are produced. For example, call records with dimension values that are desired are presented. Control is passed to operation 225 and process 200 continues.

In operation 220, the system performs a series of calculations. Such calculations may include the probability of the result code, an expected handle time value of the call, and a call yield value. For example, the historical record is searched for each dimension value for that value's ability to obtain the desired result code. Such result codes may be determined by condensing a wrap code which comprises a character string designating a classification of what occurred during a call. The probability of each resulting value (i.e., the number of success or number of attempts) is pooled, in a mathematically appropriate manner, in order to yield a probability. A resulting value may comprise a success, right party, wrong party, busy, answering machine, no answer, other handled by agent and other handled by machine. A probability for each dimension value may apply to more than one contact. Using the above example, a grouping may contain five contacts; each is a woman who is aged 45 years. Thus, these five contacts have similar dimension values for age (45 years) and gender (female). Thus, the estimated probability, expected handle time value, and/or call yield value may only need to be calculated once for a dimension value instead of for each individual contact.

The expected handle time of the call may be a weighted average of the handle times of the contributing call events. The weighted average may be weighted by the expected probability of each dimension value and across dimensions by the same appropriate method utilized for calculating the probabilities. Call yield may include a base effect on the objective such as dollar sales, dollars recovered, or patients reminded, instead of seconds on the call. Control is passed to operation 230 and process 200 continues.

In operation 225, the calculated result code probabilities for each dimension are added by the system in a mathematically appropriate manner. For example, values may be pooled for each desired result code across the desired result codes. Small denominator groups may be pooled by a simple method while large pools can be combined by using inverse expected variance weights. Control is passed back to operation 205 and process 200 continues.

Forecasting allows the agents to place calls based on calculations that determine the best time to call to yield the desired results. Contacts with the highest yield productivity are selected. For example, the highest yield productivity may be determined by multiplying the expected yield given contact with the probability of the contact and dividing this result by the expected handle time. A set of contacts may be selected with the highest sum of yield productivity to contact. Optionally, contacts with the highest yield productivity may be contacted. Results may be provided to the Dialer which dispatches the accounts to be called to the agents. Dimension values in the calculations may take into consideration a day where the behavior of the contacts is different from any other day, such as a holiday. As such, special treatment may be applied to any such day where the behavior of the contacts varies.

In another embodiment, operation 220 may only include calculating a call yield value and a probability for each result code for a said dimension value. A forecast of probability and expected call yield for a set of result codes may then be determined. Contacts with the highest yield may be selected to contact by multiplying the expected yield given contact with the highest yield of the contact and dividing this result by the expected handle time.

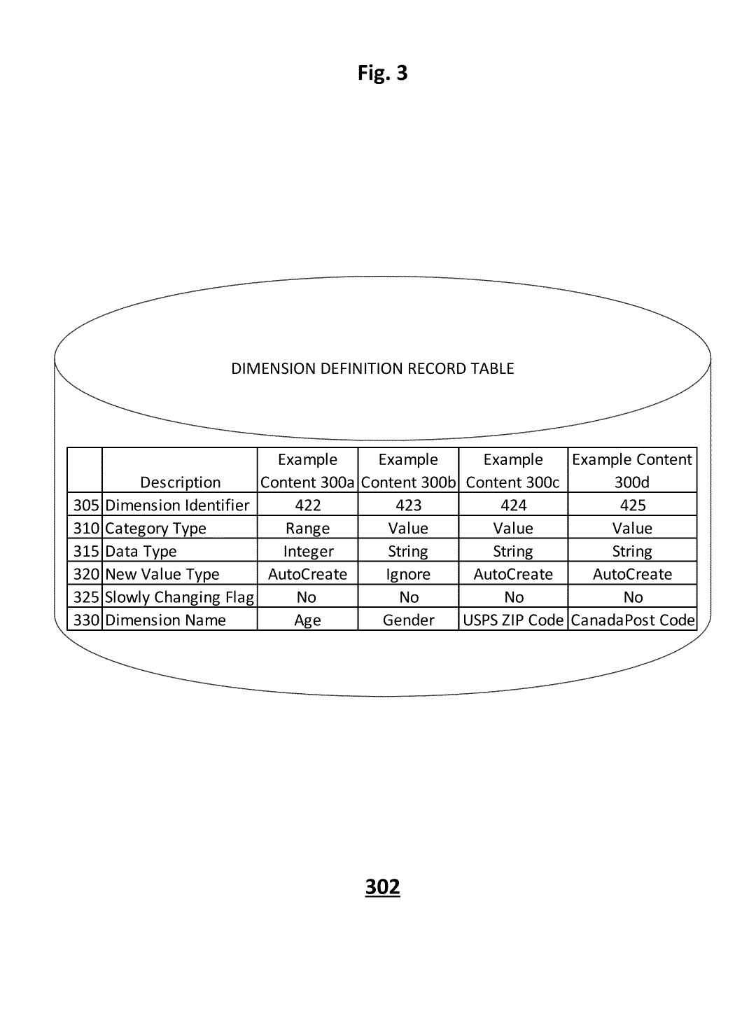

A number of records may be present to aid in forecasting. FIG. 3 illustrates a sample dimension definition record table. The dimension definition record table 302 (FIG. 3) may be composed of a number of dimension definition records 300. While only a few records 300a, 300b, 300c, and 300d have been illustrated in FIG. 3, any number of records 300 may be provided. A dimension definition record 300 may be associated with or resident in the Call Selection Database 145 (FIG. 1). A dimension definition record 300 (FIG. 3) may include a Dimension Identifier field 305, a Category Type field 310, a Data Type field 315, a New Value Type field 320, a Slowly Changing Flag field 325, and a Dimension Name field 330. The Dimension Identifier field 305 may contain an identifier of a dimension, which is necessarily unique and preferably used consistently. For example, a dimension identifier may be a randomly generated alpha-numeric code or a character string. A dimension identifier may indicate an identifier that is used relevant to each account. Although particular examples of dimension identifiers are presented herein, any sort of unique identifier may be used without departing from the scope of the embodiments herein. Using the example shown in FIG. 3, ‘422’ is the dimension identifier associated with the dimension definition record 300a. The dimension identifier ‘423’ is associated with record 300b. The dimension identifier ‘424’ is associated with record 300c. The dimension identifier ‘425’ is associated with record 300d.

Each dimension definition record may be assigned a Category Type field 310 which may indicate that the information presented may be from a given range or may be a value. For example, the dimension definition record 300a indicates that the category type is ‘Range’. This may mean that for record 300a, information is presented as a range. Dimension definition records 300b, 300c, and 300d all indicate a category type 310 of ‘Value’. This may indicate that the information is presented as a value for records 300b, 300c, and 300d.

The Data Type field 315 may indicate how data is presented in the record. Data may be presented as an integer or as a string. For example, the dimension definition record 300a indicates that the Data Type 315 is ‘Integer’. Thus, data is presented as an integer as opposed to a string of data. Dimension definition records 300b, 300c, and 300d all present a Data Type 315 of ‘String’, indicating information is presented as a string of data.

The New Value Type field 320 may indicate whether or not a field needs to be created if a value is present or absent in the database. If data is not present, then it may be automatically created by the system. If data is present other than specified, then the system may recognize this as a data error and disregard it. For example, the dimension definition records 300a, 300c, and 300d each indicate that the New Value Type 320 is ‘AutoCreate’. Thus, the system will create the data. Dimension definition record 300b indicates a New Value Type 320 of ‘Ignore’ and thus the system recognizes that it should disregard this information.

The Slowly Changing Flag field 325 may indicate information with a meaning that may slowly change over some period of time. An example of slowly changing data may be the price of an item denominated in United States Dollars, which may change its real value over time due to inflation. A flag may be placed on this information to purge the data more frequently than the system may do so otherwise. For example, the dimension definition records 300a, 300b, 300c, and 300d indicate that the Slowly Changing Flag field 325 is ‘No’. Thus, a flag would not be placed on the data in the dimension definition records 300a, 300b, 300c, and 300d to indicate that the information is changing and the system would purge the data as usual.

The Dimension Name field 330 may indicate the name given to the dimension within the record. The dimension name may be indicative of the type of information contained within a record, such as demographic information or automatic dimension data which may be extracted from a call as the system handles it. For example, the dimension definition record 300a indicates that the Dimension Name 330 is ‘Age’. The dimension definition record 300b indicates that the Dimension Name 330 is ‘Gender’. The dimension definition record 300c indicates that the Dimension Name 330 is ‘USPS ZIP Code’. The dimension definition record 300d indicates that the Dimension Name 330 is ‘Canada Post Code’.

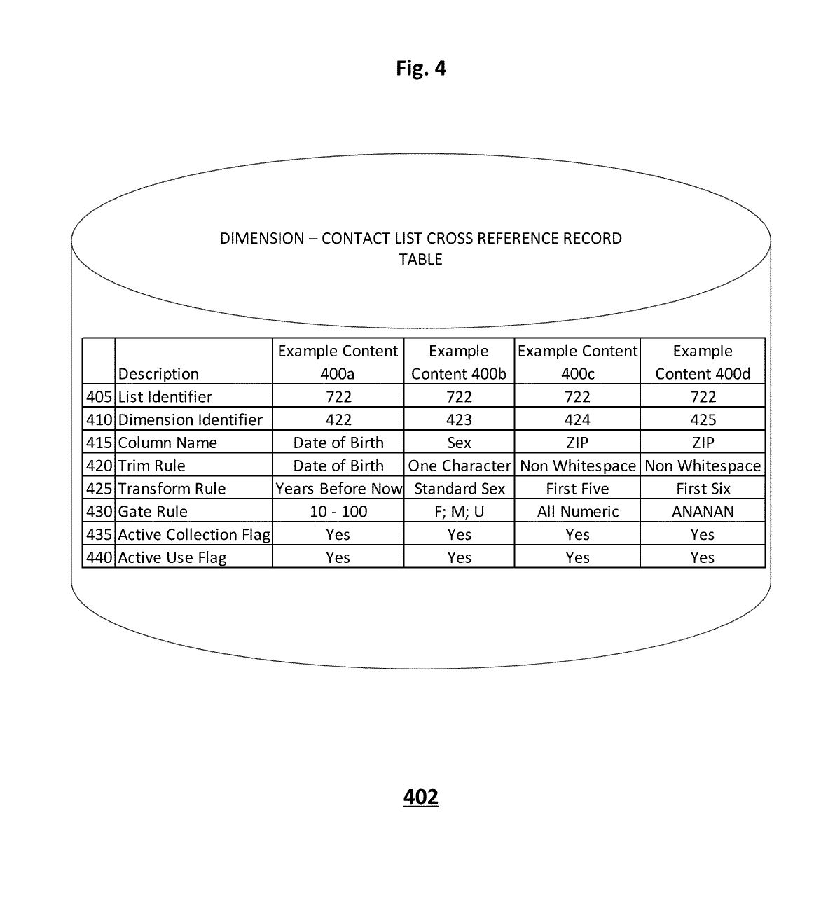

FIG. 4 illustrates a sample dimension-contact list cross reference record table. The dimension-contact list cross reference record table 402 (FIG. 4) may be composed of a number of dimension-contact list cross reference records 400. While only a few records 400a, 400b, 400c, and 400d have been illustrated in FIG. 4, any number of records 400 may be provided. A dimension-contact list cross reference record 400 may be associated with or resident in the Call Selection Database 145 (FIG. 1) or the Call Lists Database 140. A dimension-contact list cross reference record may include a List Identifier field 405 (FIG. 4), a Dimension Identifier field 410, a Column Name field 415, a Trim Rule field 420, a Transform Rule field 425, a Gate Rule field 430, an Active Collection Flag field 435, and an Active Use Flag field 440. The List Identifier field 405 may contain an identifier for a group of lists having the same format but physically different or similar information. A list identifier may be means of identification set by the user. Although particular examples of list identifiers are presented herein, any sort of unique identifier may be used without departing from the scope of the embodiments herein. Using the example shown in FIG. 4, ‘722’ is the List Identifier 405 associated with the dimension-contact list cross references records 400a, 400b, 400c, and 400d. This may indicate that these records are all part of the same list because they each have the same value in the List Identifier field 405.

The Dimension Identifier field 410 may contain an identifier of a dimension, which is necessarily unique and preferably used consistently. For example, the dimension identifier may be a randomly generated alpha-number code and/or a character string. A dimension identifier may indicate an identifier that is used relevant to each account. Although particular examples of dimension identifiers are presented herein, any sort of unique identifier may be used without departing from the scope of the embodiments herein. Using the examples provided in FIG. 4, ‘422’ is the Dimension Identifier 410 associated with the dimension-contact list cross reference record 400a, ‘423’ is associated with the dimension-contact list cross reference record 400b, ‘400c’ is associated with dimension-contact list cross reference record 400c, and ‘425’ is associated with dimension-contact list cross reference record 400d.

The Column Name field 415 may indicate the name of the column within a particular list that is being examined. In FIG. 4, for example, the Column Name field 415 indicates in the dimension-contact list cross references record 400a that the Date of Birth column is being examined within List 722. In record 400b, the Sex column is being examined within List 722, and in records 400c and 400d, the ZIP column is being examined.

The Trim Rule field 420 may indicate the desired format of the information and how the system may edit the information. A trim rule may be optionally specified by the user. Using the example provided in FIG. 4, the Trim Rule field 420 indicates for record 400a that the information is a ‘Date’ of birth and may be in a date format. Any information that does not fit this specification in the Trim Rule field 420 will be edited out by the system. For record 400b, the Trim Rule field 420 indicates ‘One Character’. Any information beyond this character will be edited out. Likewise, the Trim Rule field 420 indicates for records 400c and 400d that the information is ‘Non Whitespace’. Any whitespaces present in the data field will thus be discarded by the system.

The Transform Rule field 425 may indicate how the information is transformed for presentation in the dimension. Using the example provided in FIG. 4, the Transform Rule field 425 indicates for record 400a ‘Years Before Now’ as the transform rule. The system may recognize to transform the data into a number showing the information in the date of birth column as a number of years prior to the current date. Record 400b indicates ‘Standard Sex’ as the transform rule. The system may recognize to transform the data into a character that indicates sex of a person. Record 400c indicates that the Rule is ‘First Five’, meaning that the information is contained in the first five characters. Record 400d indicates that the Rule is ‘First Six’, meaning that the information is contained in the first six characters.

The Gate Rule field 430 may contain rules for further filtering out information by the system that does not meet the desired criteria. For example, the Gate Rule field 430 indicates for record 400a that the information is ‘10-100’ meaning the desired information falls between the values 10 and 100. Record 400b indicates that the Gate Rule 430 is ‘F’; ‘M’; ‘U’. This may indicate that the desired content is not only ‘One Character’ representing ‘Standard Sex’, but that it must be either an ‘F’, an ‘M’, or a ‘U’. Record 400c has a gate rule that is ‘All numeric’, meaning that the information is not only contained in the first five characters according to the Transform Rule field 425, but that the information is also all numbers. Record 400d has an ‘ANANAN’ Gate Rule 430. This may indicate that the ‘First Six’ characters are alpha-numeric and alternate between a letter and a number.

The Active Collection Flag field 435 may indicate whether the data should be collected on users or not. The information in this column may be in a ‘Yes’ or ‘No’ format. Using the example provided in FIG. 4, the Active Collection Flag field 435 has a value of ‘Yes’ for records 400a, 400b, 400c, and 400d, indicating that the data will be collected on the users according to this field.

The Active Use Flag field 440 may indicate whether the data collected should be used for forecasting. The Active Use Flag field 440 may have a default pre-set that can be changed by the user. For example, in the instant system, the default is set to ‘Yes’. The Active Use Flag field 440 has a value of ‘Yes’ for records 400a, 400b, 400c, and 400d indicating that the data will be used for forecasting purposes.

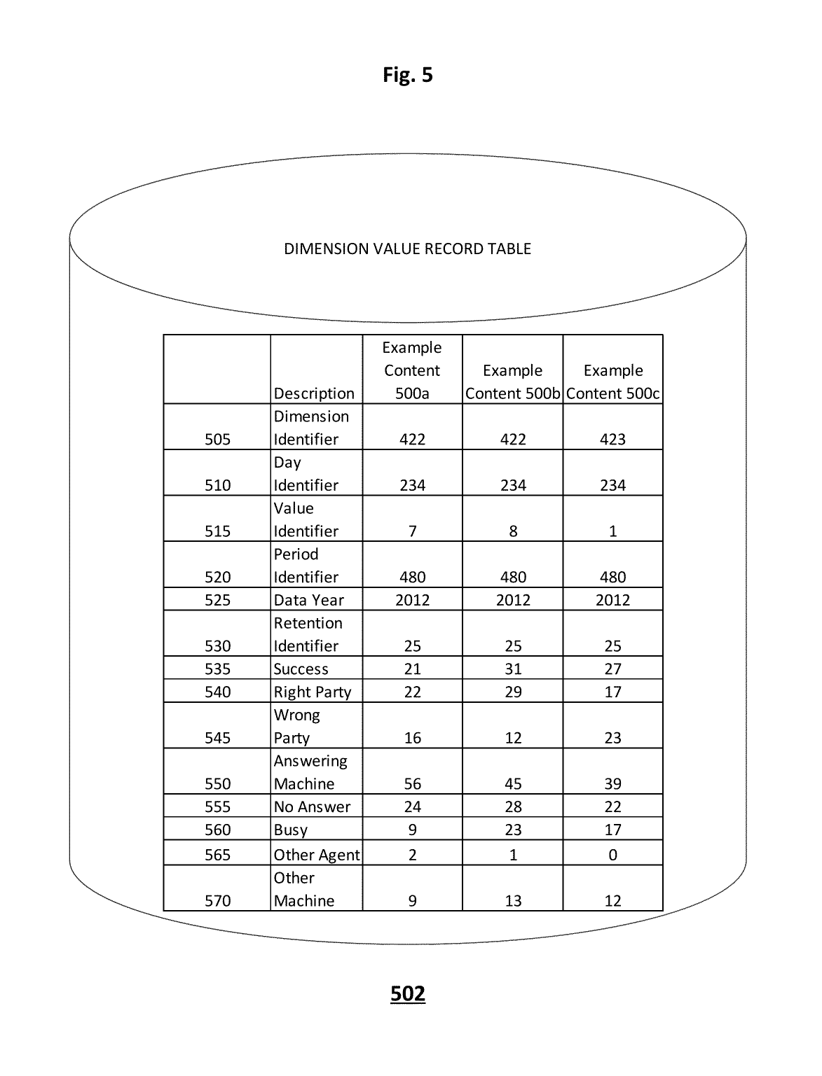

FIG. 5 illustrates a sample dimension value record table. The dimension value record table 502 (FIG. 5) may be composed of a number of dimension value records 500. While only a few records 500a, 500b, and 500c have been illustrated in FIG. 5, any number of records 500 may be produced. A dimension value record 500 may be associated with or resident in the Call Selection Database 145 (FIG. 1). A dimension value record 500 (FIG. 5) may include a Dimension Identifier field 505, a Day Identifier field 510, a Value Identifier field 515, a Period Identifier field 520, a Data Year field 525, a Retention Identifier field 530, a Success field 535, a Right Party field 540, a Wrong Party field 545, an Answering Machine field 550, a No Answer field 555, a Busy field 560, an Other Agent field 565, and an Other Machine field 570.

The Dimension Identifier field 505 may contain an identifier of a dimension, which is necessarily unique and preferably used consistently. For example, the dimension identifier may be a randomly generated alpha-numeric code and/or a character string. A dimension identifier may indicate an identifier that is used relevant to each account. Although particular examples of dimension identifiers are presented herein, any sort of unique identifier may be used without departing from the scope of the embodiments herein. Using the example provided in FIG. 5, ‘422’ is the Dimension Identifier associated with records 500a and 500b. The Dimension Identifier ‘423’ is associated with the dimension value record 500c.

The Day Identifier field 510 may identify a day with respect to its relation to the cycles of time. This field may be detailed to show the day of the year, the day of the week, the month, etc. Using the example shown in FIG. 5, ‘234’ is the day identifier for records 500a, 500b, and 500c.

The Value Identifier field 515 may identify the value that the system is collecting data on. For example, record 500a indicates a value identifier of ‘7’, record 500b indicates a value identifier of ‘8’, and record 500c indicates a value identifier of ‘1’.

The Period Identifier field 520 may indicate the period of the day. This information may be specified as minutes of the day in 15 minute blocks. For example, the dimension value records 500a, 500b, and 500c each indicate a value of ‘480’ in the Period Identifier field 520. The value ‘480’ may translate into the period of 8:00 am to 8:15 am in the time zone of the Contact.

The Data Year field 525 may indicate the year the data is collected. This field may also be used to identify older data when the system retires data if the user does not wish to retain data past a certain threshold. For example, the value present in the Data Year field 525 for records 500a, 500b, and 500c is ‘2012’. This may indicate that the data was collected in the year 2012.

The Retention Identifier field 530 may aggregate information together within a year in order that data can be retired gradually instead of purged at one time. For example, the value ‘25’ is present in the Retention Identifier field 530 for each of records 500a, 500b, and 500c. This may indicate that the 25^{th} cycle will relieve this row. If cycles occur every two weeks, then the 25^{th} cycle would occur near the end of December in a calendar year.

The Success field 535 may indicate the number of successful calls achieved by the agent. A successful call may be a call in which the agent has achieved the desired result and no longer needs to continue calling the account at present. Using the example shown in FIG. 5, the record 500a indicates a value of ‘21’ in the Success field 535, record 500b indicates a value of ‘31’ in the Success field 535, and record 500c indicates a value of ‘27’ in the Success field 535.

The Right Party field 540 may indicate information disclosing that while the right party was reached during the telephone call, no success was achieved. For example, the record 500a indicates a value of ‘22’. This may indicate that 22 calls where placed where the correct party was reached, but success was not achieved. Record 500b indicates ‘29’ right party results and record 500c indicates ‘17’.

The Wrong Party field 545 may contain information disclosing the number of calls where the desired party was not reached by the agent. For example, the desired party may not be present when the call is taken by another party. In this scenario, the call was taken by the wrong party. Using the example shown in FIG. 5, record 500a indicates a value of ‘16’ in the Wrong Party field 545. This indicates that 16 calls were taken by the wrong party. Record 500b indicates a value of ‘12’ while record 500c indicates a value of ‘23’.

The Answering Machine field 550 may contain information disclosing the number of calls where instead of reaching a party, an answering service took the call. Using the example in FIG. 5, record 500a displays the value ‘56’. This may indicate that 56 calls ended with an answering machine taking the call instead of a party. Record 500b indicates a value of ‘45’ and record 500c indicates a value of ‘39’.

The No Answer field 555 may contain information disclosing the number of calls where no response was achieved during the call. Using the example in FIG. 5, record 500a displays the value ‘24’. This may indicate that 24 calls were not answered by either a human or an answering machine. Record 500b displays a value of ‘28’ and record 500c displays a value of ‘22’.

The Busy field 560 may contain information disclosing the number of calls where the line was busy or otherwise occupied, and the agent could not get through. Using the example in FIG. 5, record 500a displays the value ‘9’. This may indicate that 9 calls did not go through because of a busy line. Record 500b displays a value of ‘23’ and record 500c displays a value of ‘17’.

The Other Agent field 565 may contain information disclosing the number of calls where an agent had to spend time on the call. For example, the PBX could give a busy signal that is not recognized by the system and the agent has to end the call on their own. Using the example in FIG. 5, record 500a displays the value ‘2’. This may indicate that 2 calls were placed where an agent had to intercede. Record 500b displays a value of ‘1’ and record 500c displays a value of ‘0’.

The Other Machine field 570 may contain information disclosing the number of calls where dead air was achieved during the call. Tri-tones may also have occurred or there was a breakdown in the communication with the server. Using the examples provided in FIG. 5, record 500a displays the value ‘9’. This may indicate that 9 calls were not answered due to a machine issue. Record 500b displays a value of ‘13’ and record 500c displays a value of ‘12’.

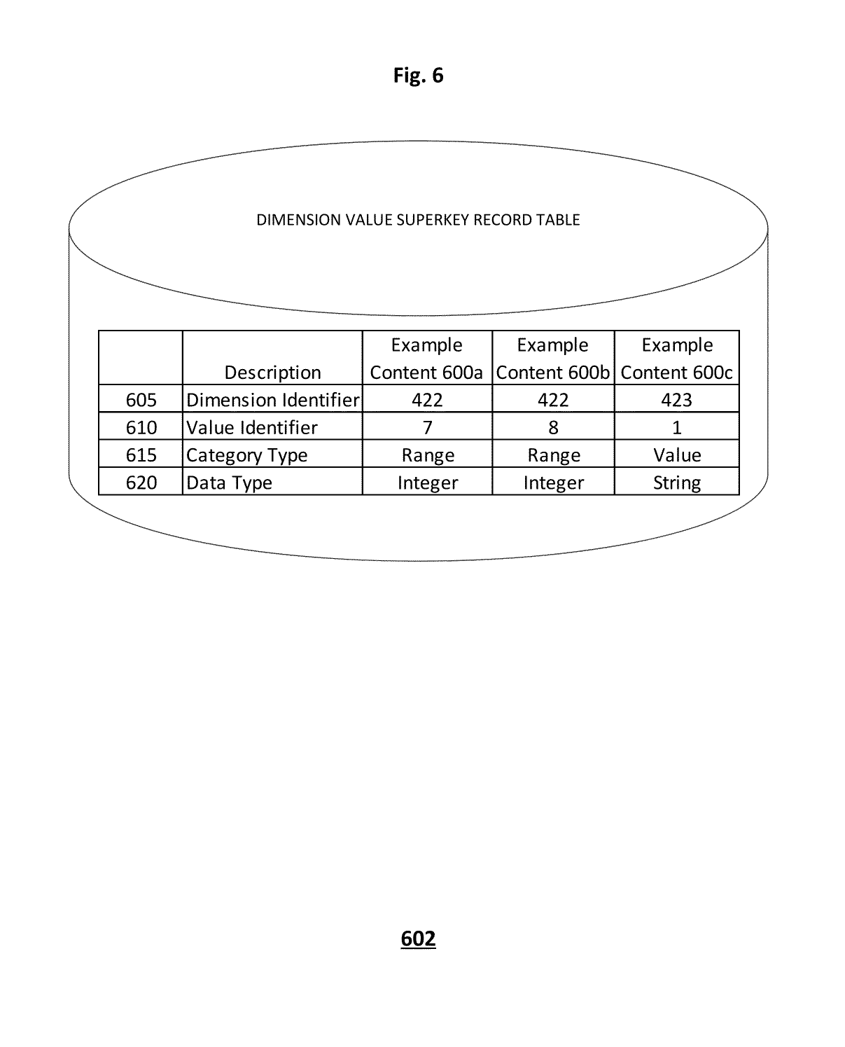

FIG. 6 illustrates a sample dimension value superkey record table. The dimension value superkey table 602 (FIG. 6) may be composed of a number of dimension value superkey records 600. While only a few records 600a, 600b, and 600c have been illustrated in FIG. 6, any number of records 600 may be produced. A dimension value superkey record may be associated with or resident in the Call Selection Database 145 (FIG. 1). A dimension value superkey record 600 (FIG. 6) may include a Dimension Identifier field 605, a Value Identifier field 610, a Category Type field 615, and a Data Type field 620.

The Dimension Identifier field 605 may contain an identifier of a dimension, which is necessarily unique and preferably used consistently. For example, the dimension identifier may be a randomly generated alpha-numeric code and/or a character string. A dimension identifier may indicate an identifier that is used relevant to each account. Although particular examples of dimension identifiers are presented herein, any sort of unique identifier may be used without departing from the scope of the embodiments herein. Using the example shown in FIG. 6, ‘422’ is the Dimension Identifier associated with the dimension definition records 600a and 600b. The Dimension Identifier ‘423’ is associated with the dimension definition record 600c.

The Value Identifier field 610 may identify the value that the system is collecting data on. For example, record 600a indicates a value identifier of ‘7’, record 600b indicates a value identifier of ‘8’, and record 600c indicates a value identifier of ‘1’.

The Category Type field 615 may indicate whether the information to be provided is a range or a value. Using the example shown in FIG. 6, the Category Type field 615 indicates that the data provided is a ‘Range’ for records 600a and 600b. The Category Type field 615 indicates that the data provided is a ‘Value’ for record 600c.

The Data Type field 620 may indicate whether the information provided is an integer or a data string. Using the example shown in FIG. 6, the Category Type field 615 indicates that the data provided is an ‘Integer’ for records 600a and 600b. The Category Type field 615 indicates that the data provided is a ‘String’ for record 600c.

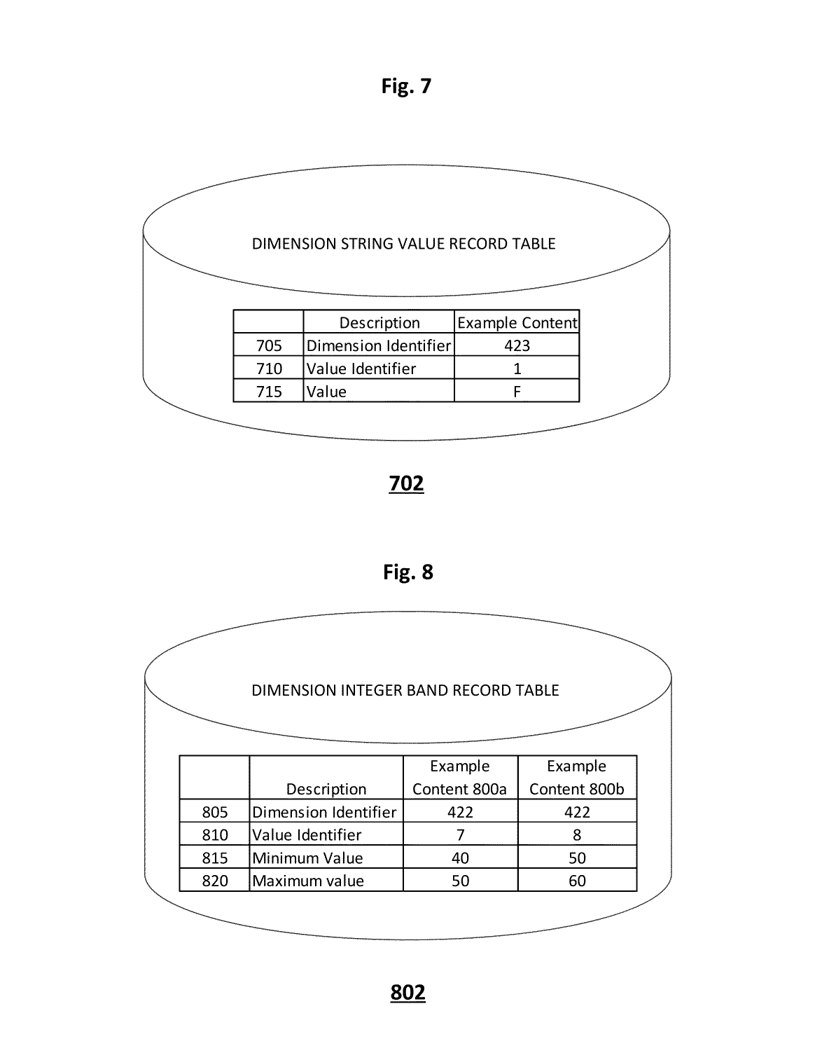

FIG. 7 illustrates a sample dimension string value record table. The dimension string value record table 702 (FIG. 7) may be composed of a number of dimension string value records 700. While only one record has been illustrated in FIG. 7, any number of records 700 may be produced. A dimension string value record 700 may be associated with or resident in the Call Selection Database 145 (FIG. 1). A dimension string value record 700 (FIG. 7) may include a Dimension Identifier field 705, a Value Identifier field 710, and a Value Field 715.

The Dimension Identifier field 705 may contain an identifier of a dimension, which is necessarily unique and preferably used consistently. For example, the dimension identifier may be a randomly generated alpha-numeric code and/or a character string. A dimension identifier may indicate an identifier that is used relevant to each account. Although particular examples of dimension identifiers are presented herein, any sort of unique identifier may be used without departing from the scope of the embodiments herein. Using the example shown in FIG. 7, ‘423’ is the Dimension Identifier associated with the dimension value record 500c.

The Value Identifier field 710 may identify the value that the system is collecting data on. For example, record 700 indicates a value identifier of ‘1’.

The Value field 715 may indicate the value of the information collected based on the Dimension Identifier field 705 and the Value Identifier field 710. For example, the value of F for female, M for Male or U for Unknown may be indicated in the table. A value identifier is assigned to the value such as 1 for F, 2 for M, and 3 for U as is indicated in the Value Identifier field 710. Using the example shown, the Value field 715 indicates a value of ‘F’ in record 700.

FIG. 8 illustrates a sample dimension integer band record table. The dimension integer band record table 802 (FIG. 8) may be composed of a number of dimension integer band records 800. While only a few records 800a and 800b have been illustrated in FIG. 8, any number of records 800 may be produced. A dimension integer band record 800 may be associated with or resident in the Call Selection Database 145 (FIG. 1). A dimension integer band record 800 (FIG. 8) may include a Dimension Identifier field 805, a Value Identifier field 810, a Minimum Value field 815, and a Maximum Value field 820.

A Dimension Identifier field 805 may contain an identifier of a dimension, which is necessarily unique and preferably used consistently. For example, the dimension identifier may be a randomly generated alpha-numeric code and/or a character string. A dimension identifier may indicate an identifier that is used relevant to each account. Although particular examples of dimension identifiers are presented herein, any sort of unique identifier may be used without departing from the scope of the embodiments herein. Using the example provided in FIG. 8, ‘422’ is the Dimension Identifier association with the dimension-contact list cross references records 800a and 800b.

The Value Identifier field 810 may identify the value that the system is collecting data on. For example, record 800a indicates a value identifier of ‘7’, record 800b indicates a value identifier of ‘8’.

The Minimum Value field 815 may contain the lower end of a numeric band specifying the range for the Value Identifier field 610 and the Category Type field 615 described in FIG. 6. As illustrated in FIG. 3, the Dimension Name field 330 indicates that the range is for an Integer to fall in based on the Data Type field 315. The Minimum Value field 815 (FIG. 8) may indicate a value of ‘40’ for record 800a. The record 800b may indicate a value of ‘50’ in the Minimum Value field 815.

The Maximum Value field 820 contains the upper end of a numeric band that specifies the range for the Value Identifier field 610 and the Category Type field 615 described in FIG. 6. As indicated in FIG. 3, the Dimension Name field 330 indicates that the range is for an Integer to fall in based on the Data Type field 315. The Maximum value field 820 indicates a value of ‘50’ for record 800a. The record 800b indicates a value of ‘60’ in the Maximum value field 820. The information provided in FIG. 8 indicates that data for record 800a is an integer between the values of 40 and 50 while for record 800b, the integer is between the values 50 and 60.

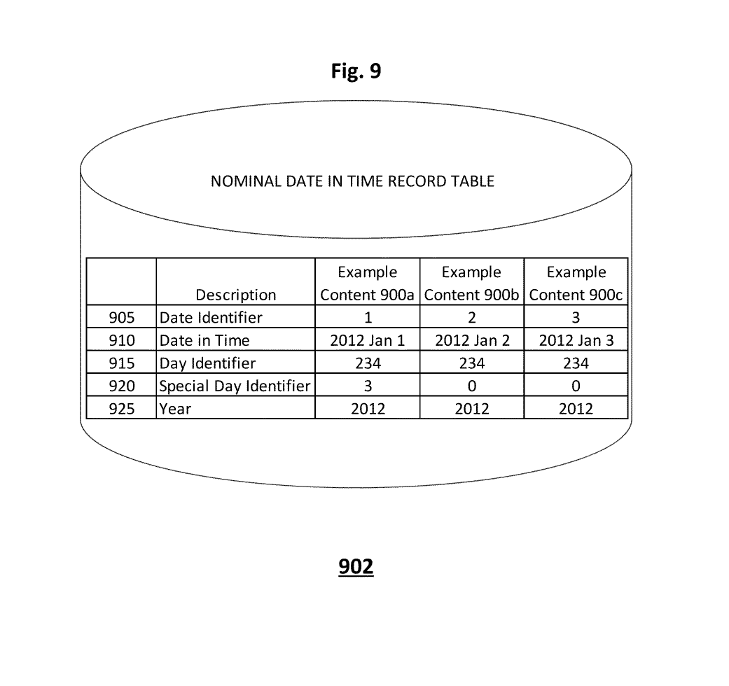

FIG. 9 illustrates a sample nominal date in time record table. The nominal date in time table 902 (FIG. 9) may be composed of a number of nominal date in time records 900. While only a few records 900a, 900b, and 900c have been illustrated in FIG. 9, any number of records 900 may be produced. A nominal date in time record may be associated with or resident in the Call Selection Database 145 (FIG. 1). A nominal date in time record 900 (FIG. 9) may include a Date Identifier field 905, a Date in Time field 910, a Day Identifier field 915, a Special Day Identifier field 920, and a Year field 925.

The Date Identifier field 905 may contain a technical key which is used for the table to identify the row of data. For example, record 900a has a value of ‘1’ in the Date Identifier field 905. Record 900b has a value of ‘2’ and 900c has a value of ‘3’.

The Date in Time field 910 may contain information used to identify the date of the record. For example, record 900a has a value of ‘2012 Jan 1’, record 900b has a value of ‘2012 Jan 2’ and record 900c has a value of ‘2012 Jan 3’. ‘2012 Jan 1’ may indicate that the data contained in record 900a is from the calendar date 2012 Jan. 1.

The Day Identifier field 915 may identify a day with respect to its relation to the cycles of time. This field may be detailed to show the day of the year, the day of the week, the month, etc. Using the example shown in FIG. 9, ‘234’ is the day identifier for records 900a, 900b, and 900c.

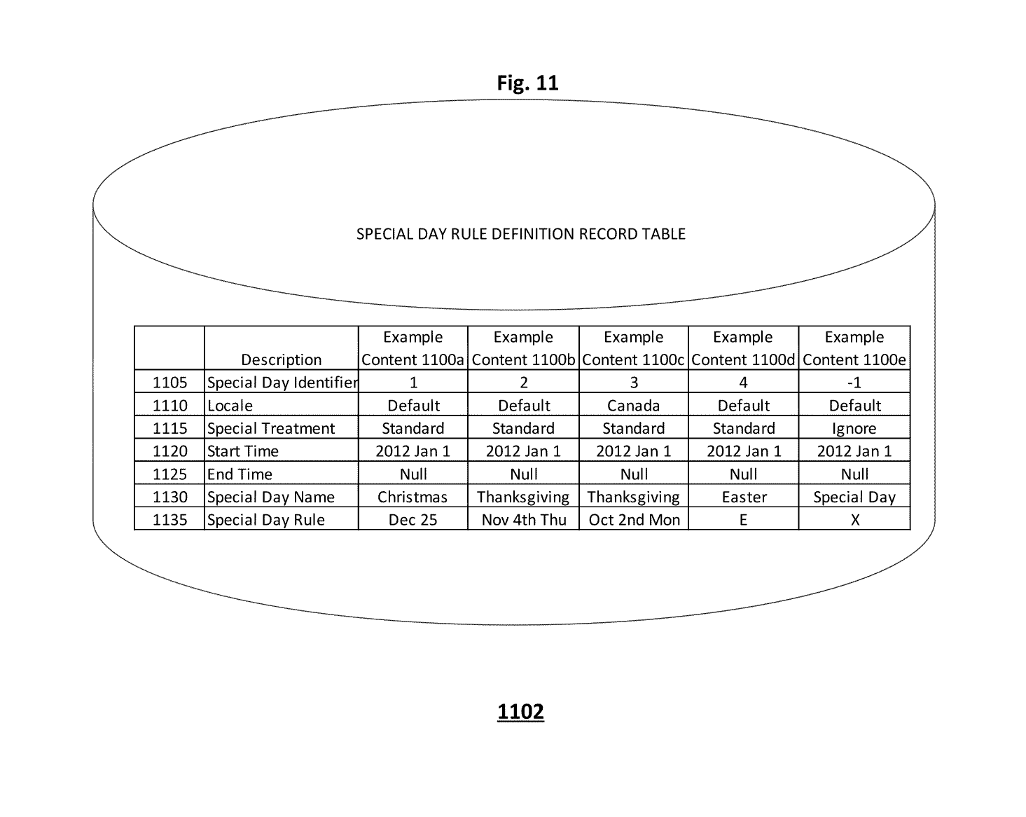

The Special Day Identifier field 920 may indicate to the system information that is connected in FIG. 11. The Special Day Identifier may indicate to the system that special information applies to this record that is different from an average date in time. Special Days may indicate information where the behavior of the contacts is different from any other day such as a day where people typically are off of work or otherwise vary their normal routine. Special Days can sometimes be forecasted, such as with a holiday, or they may not be forecasted, such as a blizzard or hurricane. The Special Day Identifier field 920 indicates a value of ‘3’ for record 900a and a value of ‘0’ for each of 900b and 900c. A value of ‘3’ may indicate to the system that this is day is a special day and that special information is associated with this record. A value of ‘0’ may indicate that the particular record is not a special day and data should thus be treated normally by the system.

A Year field 925 may the year component of the date. The Year field 925 indicates a value of ‘2012’ for each of records 900a, 900b, and 900c, indicating that the date occurs in the year 2012.

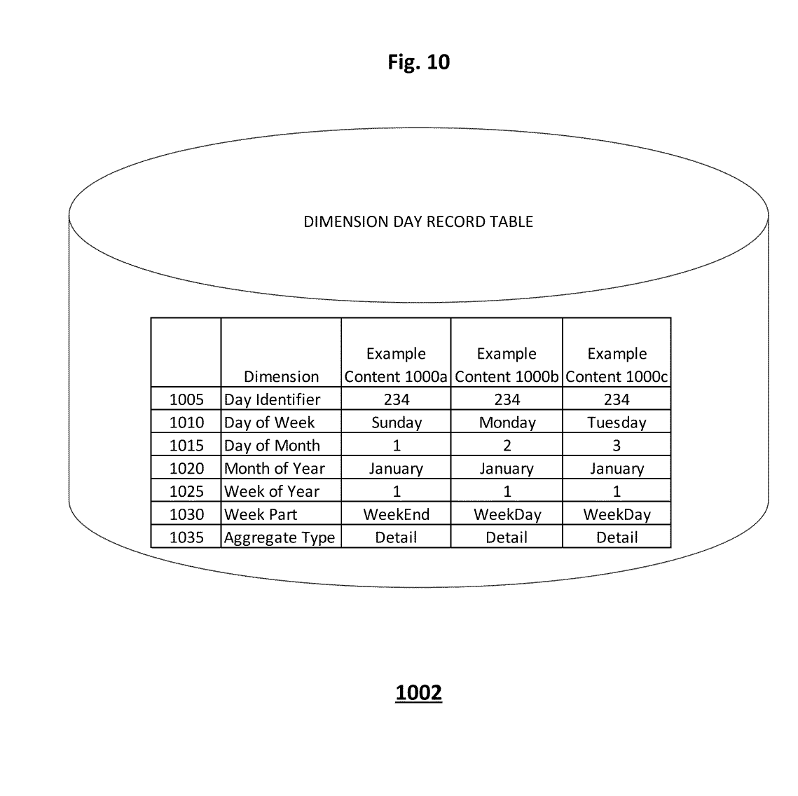

FIG. 10 illustrates a sample dimension day record table. The dimension day record table 1002 (FIG. 10) may be composed of a number of dimension day records 1000. While only a few records 1000a, 1000b, and 1000c have been illustrated in FIG. 10, any number of records 1000 may be produced. A dimension day record 1000 may be associated with or resident in the Call Selection Database 145 (FIG. 1). A dimension day record 1000 (FIG. 10) may include a Day Identifier field 1005, a Day of Week field 1010, a Day of Month field 1015, a Month of Year field 1020, a Week of Year field 1025, a Week Part field 1030, and an Aggregate Type field 1035.

The Day Identifier field 1005 may identify a day with respect to its relation to the cycles of time. This field may be detailed to show the day of the year, the day of the week, the month, etc. Using the example shown in FIG. 10, ‘234’ is the day identifier for records 1000a, 1000b, and 1000c.

The Day of Week field 1010 may indicate the day of the week the date falls on. For example, Record 1000a falls on ‘Sunday’, record 1000b falls on ‘Monday’ and record 1000c falls on ‘Tuesday’.

The Day of Month field 1015 may indicate the day of the month that the date occurs on. For example, record 1000a has a value of ‘1’, which may indicate that the date occurs on the first day of the month. Record 1000b has a value of ‘2’, which may indicate that the date occurs on the second day of the month. Record 1000c has a value of ‘3’, which may indicate that the date occurs on the third day of the month.

The Month of Year field 1020 may indicate the month that the date occurs in during a given calendar year. For example, records 1000a, 1000b, and 1000c all occur in the month of ‘January’.

The Week of Year field 1025 may indicate which week that the date occurs in during a given calendar year. For example, records 1000a, 1000b, and 1000c all have a value of ‘1’, which may indicate that these dates occur within the first week of the calendar year.

The Week Part field 1030 may indicate whether the date occurs on a weekend or a weekday. For example, record 1000a has a value of ‘WeekEnd’, indicating that the date may occur on the weekend as opposed to a weekday. Records 1000b and 1000c have a value of ‘WeekDay’, indicating that their dates may occur on a weekday as opposed to a weekend. Days that are weekends may include Saturday and Sunday while weekdays might include Monday, Tuesday, Wednesday, Thursday, and Friday, depending upon the location where the system is used.

The Aggregate Type field 1035 may indicate a value of ‘Detail’ or ‘Aggregate’ depending on the amount of information present. If the table has all values fill in, then a user may select a ‘Detail’ view to see all of the information. In a case where the user does not wish to see all of the information, or pieces are missing, a user may select to look at only some of the information. For example, records 1000a, 1000b, and 1000c indicate the value ‘Detail’ in the table, which may indicate that the user wishes to look at all of the information contained in the table.

FIG. 11 illustrates a sample special day rule definition record table. The special day rule definition record table 1102 (FIG. 11) may be composed of a number of special day rule definition records 1100. While only a few records 1100a, 1100b, 1100c, 1100d, and 1100e have been illustrated in FIG. 11, any number of records 1100 may be produced. A special day rule definition record 1100 may be associated with or resident in the Call Selection Database 145 (FIG. 1). A special day rule definition record 1100 (FIG. 11) may include a Special Day Identifier field 1105, a Locale field 1110, a Special Treatment field 1115, a Start Time field 1120, an End Time field 1125, a Special Day Name field 1130, and a Special Day Rule field 1135.

The Special Day Identifier field 1105 may indicate to the system that special information applies to this record that is different from an average date in time. Special Days may indicate information where the behavior of the contacts is different from any other day such as a day where people typically are off of work or otherwise vary their normal routine. These can sometimes be forecasted, such as with a holiday, or they may not be forecasted, such as a blizzard or hurricane. The Special Day Identifier field 1105 indicates a value of ‘1’ for record 1100a, a value of ‘2’ for record 1100b, a value of ‘3’ for record 1100c, a value of ‘4’ for record 1100d, and a value of ‘−1’ for record 1100e.

The Locale field 1110 may indicate the location of the special day, such as a particular region or country. For example, records 1100a, 1100b, 1100d, and 1100e indicate a locale of ‘Default’ which may indicate that this is the locale where the system is being utilized. Record 1100c indicates a locale of ‘Canada’ which may indicate that this is the country where the special day is occurring, but not anywhere else.

The Special Treatment field 1115 may indicate how the system should treat a special day once one has been identified. The system may ignore the special day; provide standard treatment, or any other such treatment as specified. For example, records 1100a, 1100b, 1100c, and 1100d indicate ‘Standard’ special treatment. Record 1100e indicates ‘Ignore’ in the Special Treatment field 1115. The system may thus ignore this special day.

The Start Time field 1120 may indicate the beginning of the period to recognize a special day. For example, records 1100a, 1100b, 1100c, 1100d, and 1100e indicate a start time of ‘2012 Jan 1’, which may indicate that the system begins recognition of the special days on the 1 of January 2012.

The End Time field 1125 may indicate the end of the period to recognize a special day. For example, records 1100a, 1100b, 1100c, 1100d, and 1100e indicate an end time of ‘NULL’, which may indicate that the system has no end time for recognition of the special days.

The Special Day Name Field 1130 may indicate the name of the special day recognized. For example, record 1100a indicates that the name of the special day is ‘Christmas’. Records 1100b and 1100c indicate ‘Thanksgiving’. Record 1100d indicates ‘Easter’ and record 1100e indicates ‘Special Day’.

The Special Day Rule field 1135 may indicate the date the special day occurs on as a rule for the system to recognize it. The rule may be presented in any number of formats such as, for example, a day and month, a weekday, a calculation, etc. For example, record 1100a indicates ‘Dec 25’ which may indicate that Special Day Name ‘Christmas’ should be recognized as occurring on ‘Dec 25’ by the system. Record 1100b indicates ‘Nov 4^{th} Thu’ which may indicate that Special Day Name ‘Thanksgiving’ should be recognized as occurring on the fourth Thursday of November by the system. Record 1100c indicates ‘Oct 2^{nd} Mon’which may indicate that Special Day Name ‘Thanksgiving’ should be recognized as occurring on the second Monday of October by the system. Record 1100d indicates ‘E’ which may indicate that Special Day Name ‘Easter’ should be calculated by the system. Record 1100e indicates ‘X’ which may indicate that the day cannot be forecasted.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method for increasing productivity in a contact center, the method comprising the steps of:
a) requesting contact information from a database;
b) parsing dimension values of said contact information provided by said database and extracting specified dimension values;
c) producing records containing said specified dimension values;
d) performing a series of calculations to determine an expected call handle time value, a call yield value, and a probability for each result code for a said dimension value; and
e) determining a forecast of probability, an expected handle time, and an expected call yield for a set of result codes.

2. The method of claim 1, wherein step (d) further comprises the step of:
d.1) searching said dimension value historical records for dimension values for said dimension value's ability to obtain a result code;
d.2) pooling a probability from each result of step (a); and
d.3) calculating a probability.

3. The method of claim 1, wherein step (d) further comprises the step of:
d.1) calculating a result code by condensing a wrap code which comprises a character string designating a classification of what occurred during a call.

4. The method of claim 3 further comprising the step of:
d.1.1) designating said result code as one or more of: success, right party, wrong party, answering machine, busy, no answer, other handled by agent, and other handled by machine.

5. The method of claim 1, wherein step (b) further comprises the step of:
b.1) extracting from said contact information one or more of: automatic dimension data, time dimension data, and demographic dimension data.

6. The method of claim 5, wherein the automatic dimension data is extracted from a call as the system and handles the call.

7. The method of claim 5, wherein the automatic dimension data comprises one or more of: a result of a call, a type of telephone user, a length of a call, a length of time that a contact is placed on hold, an escalation status of a call, a time zone offset of a telephone, and a time zone name of a telephone.

8. The method of claim 5, wherein the time dimension data is extracted from a call in consideration of a time the call was initiated.

9. The method of claim 5, wherein the time dimension data comprises one or more of: a time of day taken in intervals, a day of the week of a call, a month of the year of a call, and a year of a call.

10. The method of claim 5, wherein the demographic dimension data is extracted from designated values in designated fields in a database containing contact lists.

11. The method of claim 5, wherein the demographic dimension data comprises one or more of: a location, a primary telephone area code, a gender, a marital status, a balance due, a postal code, a credit score, an age, an income, a profession, and a residence status.

12. The method of claim 5, wherein the demographic dimension data is conditionally defined.

13. The method of claim 5, wherein the demographic dimension data is user defined.

14. The method of claim 5, wherein the demographic dimension data is automatically provided.

15. The method of claim 1, wherein step (e) further comprises the step of:
e.1) determining contacts to call with a highest yield productivity by multiplying an expected yield given contact with a probability of the contact;
e.2) dividing the result of step (e.1) by an expected handle time; and
e.3) selecting contacts with the highest yield productivity to contact.

16. The method of claim 1, wherein step (e) further comprises the step of:
e.1) determining contacts to call with a highest yield productivity by multiplying an expected yield given contact with a probability of the contact;
e.2) and dividing the result of step (e.1) by an expected handle time; and
e.3) selecting a set of contacts with the highest sum of yield productivity to contact.

17. The method of claim 1, wherein the dimension values exclude a day wherein the behavior of contacts is expected to be different from other days.

18. The method of claim 17, wherein the day is a holiday.

19. The method of claim 17, wherein special treatment is applied to said day wherein said behavior of the contacts is expected to be different from other days.

20. The method of claim 1, wherein the expected handle time is calculated as a weighted average of handle times of contributing call events.

21. The method of claim 20, wherein the expected handle time is weighted by expected probability of each dimension value and across dimensions by a mathematically appropriate method.

22. A method for increasing total yield in a contact center, the method comprising the steps of:
a) requesting contact information from a database;
b) parsing dimension values of said contact information provided by said database and extracting specified dimension values;
c) producing records containing said specified dimension values;
d) performing a series of calculations to determine a call yield value and a probability for each result code for a said dimension value; and
e) determining a forecast of probability and an expected call yield for a set of result codes.

23. The method of claim 22, wherein step (e) further comprises the step of:
e.1) determining contacts to call with a highest yield by multiplying an expected yield given contact with a highest yield of the contact;
e.2) dividing the result of step (e.1) by an expected handle time; and
e.3) selecting contacts with the highest yield to contact.

24. The method of claim 22, wherein step (b) further comprises the step of:
b.1) extracting from said contact information one or more of: automatic dimension data, time dimension data, and demographic dimension data.

25. The method of claim 24, wherein the automatic dimension data is extracted from a call as the system and handles the call.

26. The method of claim 24, wherein the automatic dimension data comprises one or more of: a result of a call, a type of telephone user, a length of a call, a length of time a contact is placed on hold, an escalation status of a call, a time zone offset of a telephone, and a time zone name of a telephone.

27. The method of claim 24, wherein the time dimension data is extracted from a call in consideration of a time the call was initiated.

28. The method of claim 24, wherein the time dimension data comprises one or more of: a time of day taken in intervals, a day of the week of a call, a month of the year of a call, and a year of a call.

29. The method of claim 24, wherein the demographic dimension data is extracted from designated values in designated fields in a database containing contact lists.

30. The method of claim 24, wherein the demographic dimension data comprises one or more of: a location, a primary telephone area code, a gender, a marital status, a balance due, a postal code, a credit score, an age, an income, a profession, and a residence status.

31. The method of claim 24, wherein the demographic dimension data is conditionally defined.

32. The method of claim 24, wherein the demographic dimension data is user defined.

33. The method of claim 24, wherein the demographic dimension data is automatically provided.

34. A method for increasing productivity in a contact center, the method comprising the steps of:
a) requesting contact information from a database, wherein said database is capable of determining an effective outcome for call yield;
b) parsing dimension values of said contact information provided by said database and extracting specified dimension values;
c) producing records containing said specified dimension values;
d) performing a series of calculations to determine an expected call handle time value, a call yield value, and a probability from a result code for said dimension value wherein said calculations comprise one or more of the following:
i. searching a historical record for each dimension value for an ability of said value to obtain a desired code in a mathematically appropriate manner;
ii. pooling a probability of each resulting value and determining a probability in a mathematically appropriate manner;
iii. determining a weighted average of the handle times of a call in a mathematically appropriate manner;
iv. pooling values for each desired result code across all desired result codes in a mathematically appropriate manner; and
e) determining a forecast of an expected handle time and an expected call yield.

35. A system for increasing productivity in a contact center comprising:
a) means for requesting contact information from a database capable of determining an effective outcome for a call yield;
b) means for parsing dimension values of said contact information;
c) means for producing records containing said specified dimension values;
d) means for performing a series of calculations to determine an expected call handle time value, a call yield value, and a probability for each result code for a said dimension value; and
e) means for determining a forecast of probability, an expected handle time, and an expected call yield for a set of result codes.

36. A system for increasing total yield in a contact center, the method comprising the steps of:
a) means for requesting contact information from a database;
b) means for parsing dimension values of said contact information provided by said database and extracting specified dimension values;
c) means for producing records containing said specified dimension values;
d) means for performing a series of calculations to determine a call yield value and a probability for each result code for a said dimension value; and
e) means for determining a forecast of probability and an expected call yield for a set of result codes.
